(19) United States
(12) Patent Application Publication
(10) Pub. No.: US 2026/0341619 A1
(43) Pub. Date: Oct. 29, 2026

(54) CONTACTOR MOVABLE CONTACT MODULE, CONTACTOR MOVABLE CONTACT ASSEMBLY AND CONTACTOR

(71) Applicants: Tyco Electronics (Shanghai) Co., Ltd., Shanghai (CN); Tyco Electronics Technology (SIP) Co., Ltd., Suzhou (CN)

(72) Inventors: Zesheng Jiang, Suzhou (CN); Quarry (Bingfeng) Qu, Suzhou (CN); Kevin (Xujia) Wang, Suzhou (CN); Lizhong Wang, Shanghai (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/551,737

(22) Filed: Feb. 27, 2026

(30) Foreign Application Priority Data
Feb. 28, 2025 (CN) 202520341500.5

(51) Int. Cl. H01H 50/54; H01H 1/30; H01H 50/64

(52) U.S. Cl. CPC H01H 50/546; H01H 1/30; H01H 50/645; H01H 2229/044

(57) ABSTRACT

A contactor movable contact module includes a plurality of movable contacts arranged side by side in a transverse direction. Rach movable contact includes a movable terminal and two movable contact points. The movable terminal has two ends opposite in a longitudinal direction and a front surface and a back surface opposite in a height direction. The two movable contact points are respectively formed on the front surfaces of the two ends of the movable terminal. The movable contact points at both ends of the plurality of movable contacts respectively simultaneously electrically contact static contact points of two static contacts to electrically connect the two static contacts.

### CROSS-REFERENCE TO RELATED APPLICATION

This application claims the benefit of the filing date under 35 U.S.C. § 119(a)-(d) of Chinese Patent Application No. CN 202520341500.5 filed on Feb. 28, 2025, the whole disclosure of which is incorporated herein by reference.

### FIELD OF THE INVENTION

The present invention relates to a contactor movable contact module and, more particularly, to a contactor movable contact module, a contactor movable contact assembly comprising the contactor movable contact module, and a contactor comprising the contactor movable contact assembly.

### BACKGROUND OF THE INVENTION

The movable contact inside the high-voltage direct current contactor is generally a single one, which carries all the load current. Due to the fact that a single movable contact has only two movable contact points, the current flowing through each movable contact point is relatively large. Under high current conditions, the movable contact point generates more heat, making it easier for the movable contact point to be thermally fused to the static contact point. Under short-circuit current, a large electric repulsion force will be generated, which can easily cause the movable contact point to accidentally separate from the static contact point.

### SUMMARY OF THE INVENTION

A contactor movable contact module includes a plurality of movable contacts arranged side by side in a transverse direction. Rach movable contact includes a movable terminal and two movable contact points. The movable terminal has two ends opposite in a longitudinal direction and a front surface and a back surface opposite in a height direction. The two movable contact points are respectively formed on the front surfaces of the two ends of the movable terminal. The movable contact points at both ends of the plurality of movable contacts respectively simultaneously electrically contact static contact points of two static contacts to electrically connect the two static contacts.

### BRIEF DESCRIPTION OF THE DRAWINGS

The invention will now be described by way of example with reference to the accompanying figures, of which:

FIG. 1 is a perspective view of a contactor movable contact module according to an exemplary embodiment;

FIG. 2 is an exploded top view of the contactor movable contact module of FIG. 1;

FIG. 3 is an exploded bottom view of the contactor movable contact module FIG. 1;

FIG. 4 is a perspective view of multiple movable contacts of the contactor movable contact module of FIG. 1;

FIG. 5 is a perspective view of a contactor movable contact assembly according to an exemplary embodiment;

FIG. 6 is an exploded view of the contactor movable contact assembly of FIG. 5;

FIG. 7 is a plan view of the contactor movable contact assembly of FIG. 5 and two static contacts according to an exemplary embodiment, where the contactor movable contact assembly is in an open position;

FIG. 8 is a plan view of the contactor movable contact assembly of FIG. 5 and the two static contacts of FIG. 7, where the contactor movable contact assembly is in a closed position;

FIG. 9 is a perspective view of a contactor movable contact module according to another exemplary embodiment;

FIG. 10 is an exploded top view of the contactor movable contact module according to FIG. 9;

FIG. 11 is an exploded bottom view of the contactor movable contact module according to FIG. 9;

FIG. 12 is a perspective view of multiple movable contacts of the contactor movable contact module of FIG. 9;

FIG. 13 is a perspective view of a contactor movable contact assembly according to another exemplary embodiment;

FIG. 14 is a perspective top view of a contactor movable contact module according to yet another exemplary embodiment;

FIG. 15 is a perspective bottom view of the contactor movable contact module of FIG. 14;

FIG. 16 is an exploded bottom view of the contactor movable contact module of FIG. 14; and

FIG. 17 is a perspective view of a contactor movable contact assembly according to yet another exemplary embodiment.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

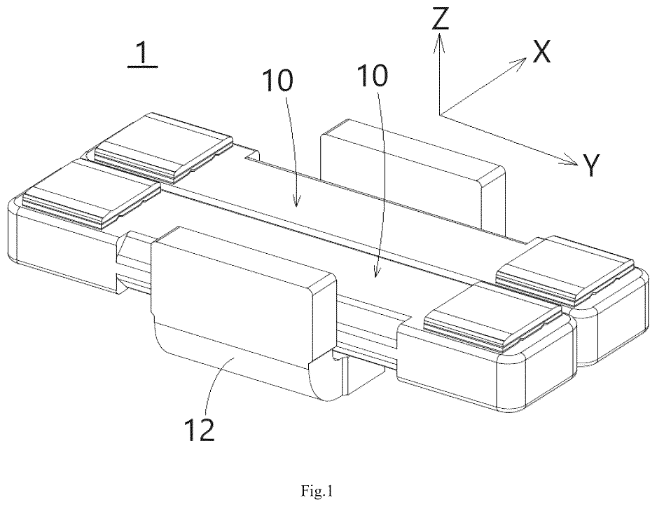

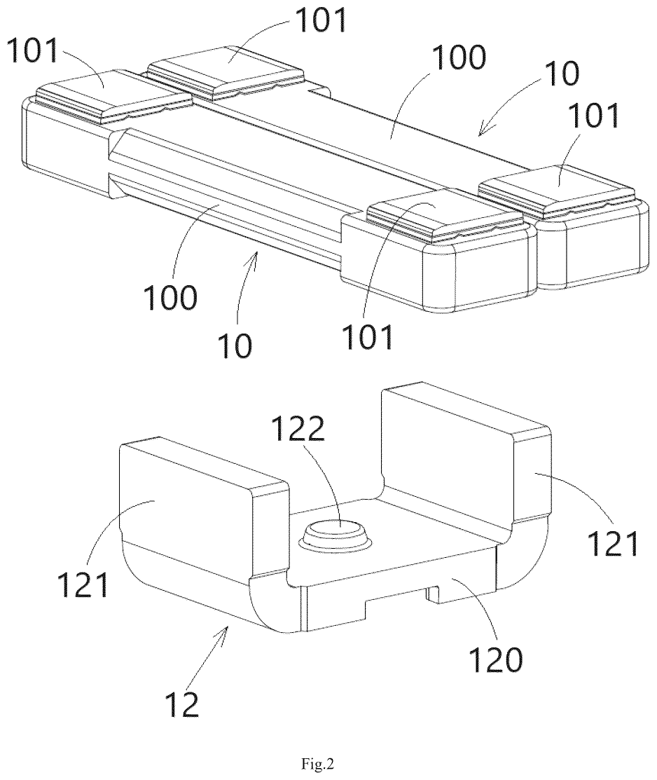

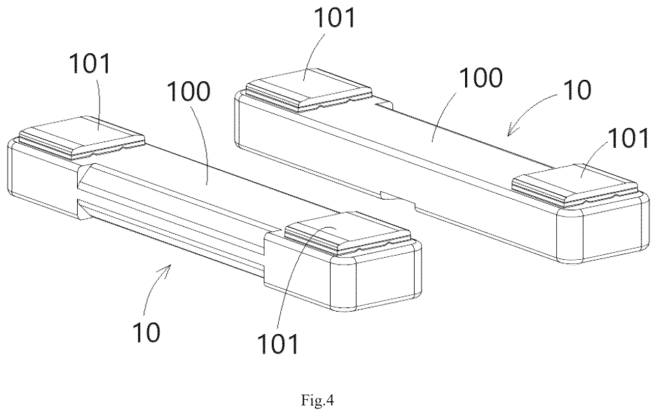

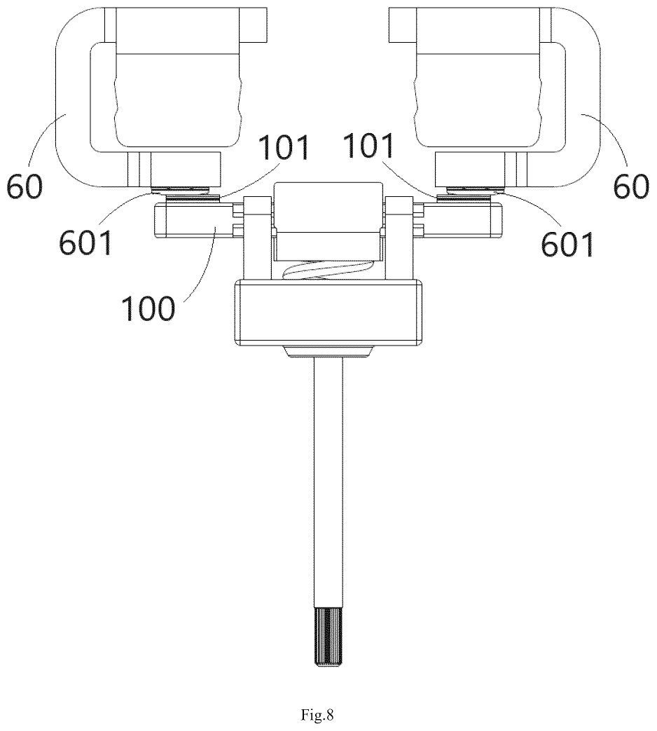

An exemplary embodiment of a contactor movable contact module 1 will now be described with reference to FIG. 1-8. As shown in FIGS. 1-2 and 4, the contactor movable contact module 1 includes multiple movable contacts 10. The multiple movable contacts 10 are arranged side by side in a transverse direction X. As shown in FIGS. 2 and 4, each movable contact 10 includes a movable terminal 100 and two movable contact points 101. The movable terminal 100 has two opposite ends in a longitudinal direction Y and front and back surfaces opposite in a height direction Z. The two movable contact points 101 are respectively formed on the front surfaces of the two ends of the movable terminal 100. As shown in FIG. 8, the movable contact points 101 at both ends of the multiple movable contacts 10 are suitable for simultaneous electrical contact with static contact points 601 of two static contacts 60, respectively, to electrically connect the two static contacts 60.

As shown in FIGS. 1-2 and 4, the contactor movable contact module 1 includes two movable contacts 10 arranged side by side. However, the present invention is not limited to this, and the contactor movable contact module 1 may include three, four, or more movable contacts 10 arranged side by side.

As shown in FIG. 2, the contactor movable contact module 1 further comprises a support seat 12, which is U-shaped and includes a bottom wall 120 and a pair of side walls 121. The movable terminals 100 of multiple movable contacts 10 are assembled in the support seat 12, and the bottom wall 120 of the support seat 12 is supported on the back of the multiple movable terminals 100. The pair of side walls 121 of the support seat 12 respectively rest on the side surfaces of the two outermost movable terminals 100.

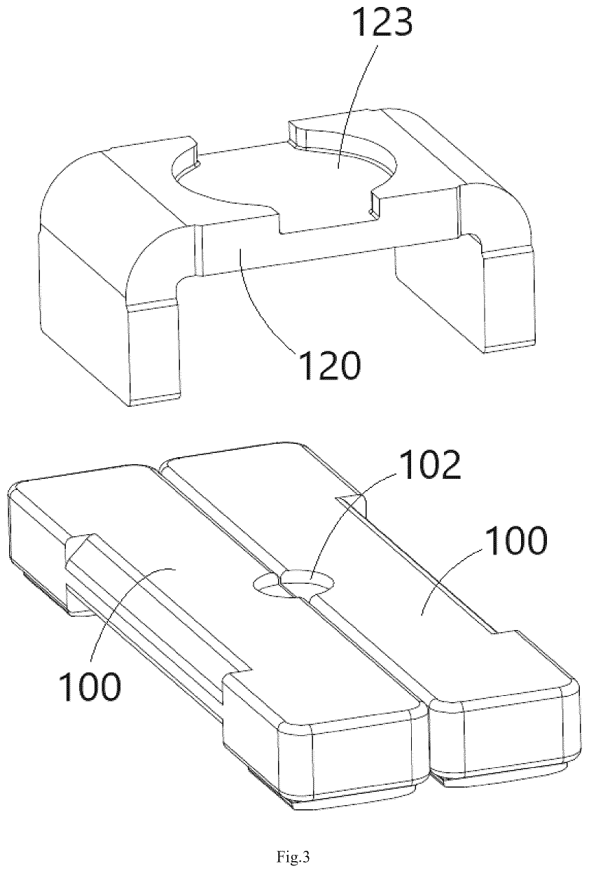

A positioning protrusion 122, as shown in FIG. 2, is formed on the bottom wall 120 of the support seat 12, and a positioning slot 102, as shown in FIG. 3, is formed on the back of the multiple movable terminals 100. The positioning protrusion 122 is positioned in the positioning slot 102.

In another embodiment of the present invention, the multiple positioning protrusions 122 are formed on the bottom wall 120 of the support seat 12, and positioning slots 102 are respectively formed on the back surfaces of multiple movable terminals 100. The multiple positioning protrusions 122 are respectively positioned in the positioning slots 102 of the multiple movable terminals 100.

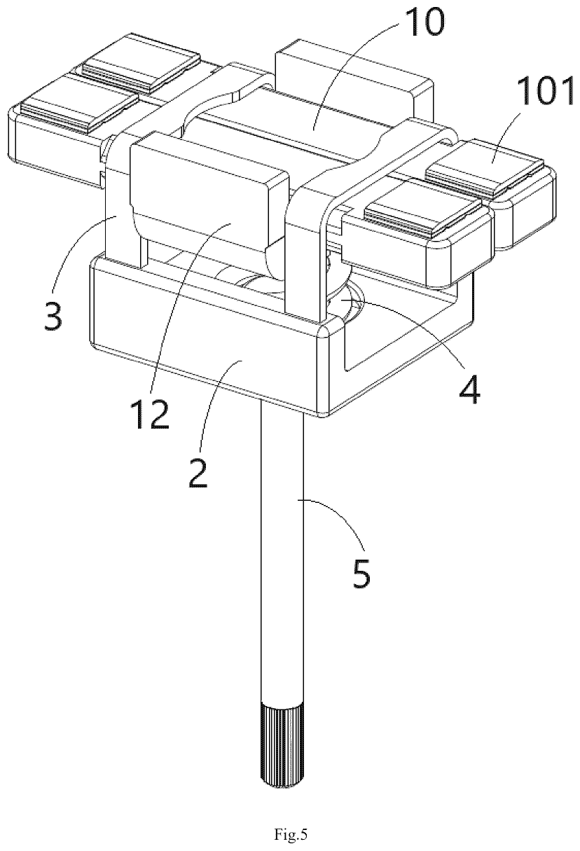

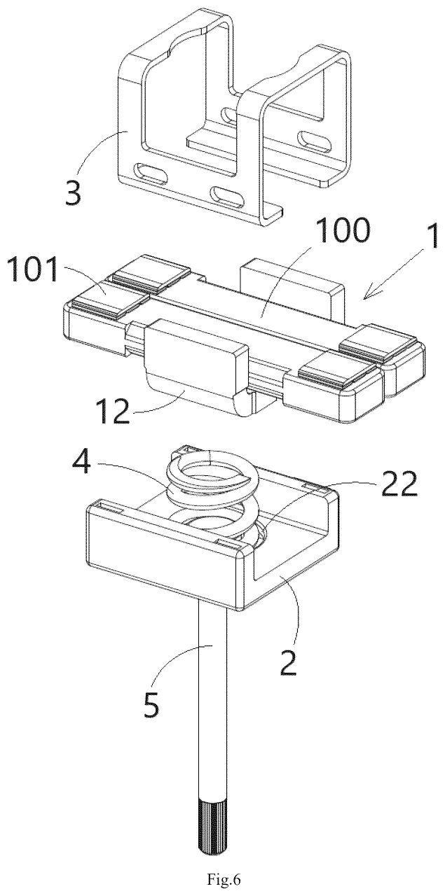

An exemplary embodiment of a contactor movable contact assembly will now be described with reference to FIGS. 1-8. As shown in FIGS. 5-6, the contactor movable contact assembly includes: the contactor movable contact module 1, an insulation seat 2, a limit bracket 3, a spring 4, and a drive shaft 5. The limit bracket 3 is fixed to and located above the insulation seat 2. The contactor movable contact module 1 is installed into the limit bracket 3 in a movable manner. The spring 4 is compressed between the insulation seat 2 and the contactor movable contact module 1, allowing the contactor movable contact module 1 to float relative to the insulation seat 2. The drive shaft 5 is fixed to and located below the insulation seat 2. The insulation seat 2 electrically isolates the limit bracket 3, the spring 4, and the drive shaft 5 from each other. The insulation seat 2 is injection molded onto the lower end of the limit bracket 3 and the upper end of the drive shaft 5, making the insulation seat 2, limit bracket 3, and drive shaft 5 an integrated piece.

As shown in FIG. 3, the contactor movable contact module 1 includes the support seat 12, and a first positioning slot 123 is formed on the bottom surface of the support seat 12. A second positioning slot 22, as shown in FIG. 6, is formed on the top surface of the insulation seat 2. The two ends of the spring 4 are respectively positioned in the first positioning slot 123 and the second positioning slot 22.

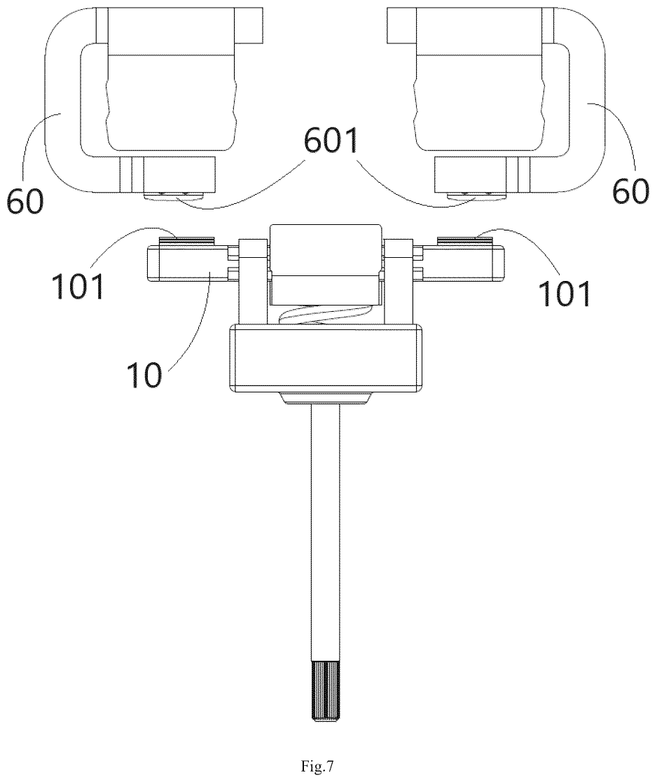

An exemplary embodiment of a contactor will now be described with reference to FIGS. 1-8. As shown in FIGS. 6-8, the contactor includes an inner housing, two static contacts 60, and a contactor movable contact assembly. An arc extinguishing chamber is defined in the inner housing. The two static contacts 60 are fixed to the inner housing and their static contact points 601 are located in the arc extinguishing chamber. The contactor movable contact assembly is installed in the arc extinguishing chamber and can be moved between a closed position and an open position. As shown in FIG. 8, when the contactor movable contact assembly is moved to the closed position, the movable contact points 101 at both ends of the multiple movable contacts 10 make electrical contact with the static contact points 601 of the two static contacts 60, respectively, to electrically connect the two static contacts 60. As shown in FIG. 7, when the contactor movable contact assembly is moved to the open position, the movable contact points 101 at both ends of multiple movable contacts 10 separate from the static contact points 601 of two static contacts 60.

The contactor further comprises an outer housing and an electromagnetic drive assembly. The inner housing is installed into the outer housing. The electromagnetic drive assembly is installed into the outer housing and located below the inner housing. The electromagnetic drive assembly is suitable for applying electromagnetic driving force on the drive shaft 5 of the contactor movable contact assembly to drive the contactor movable contact assembly to move from the open position to the closed position.

The contactor further comprises a reset spring, which is provided in the electromagnetic drive assembly and is suitable for applying an elastic reset force on the drive shaft 5. When the electromagnetic drive assembly loses power, the electromagnetic driving force applied to the drive shaft 5 disappears, and the drive shaft 5 is reset from the closed position to the open position under the action of the reset spring.

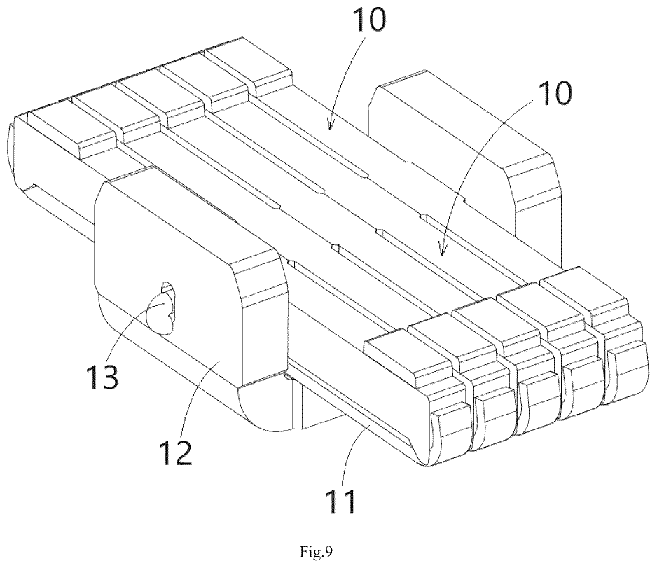

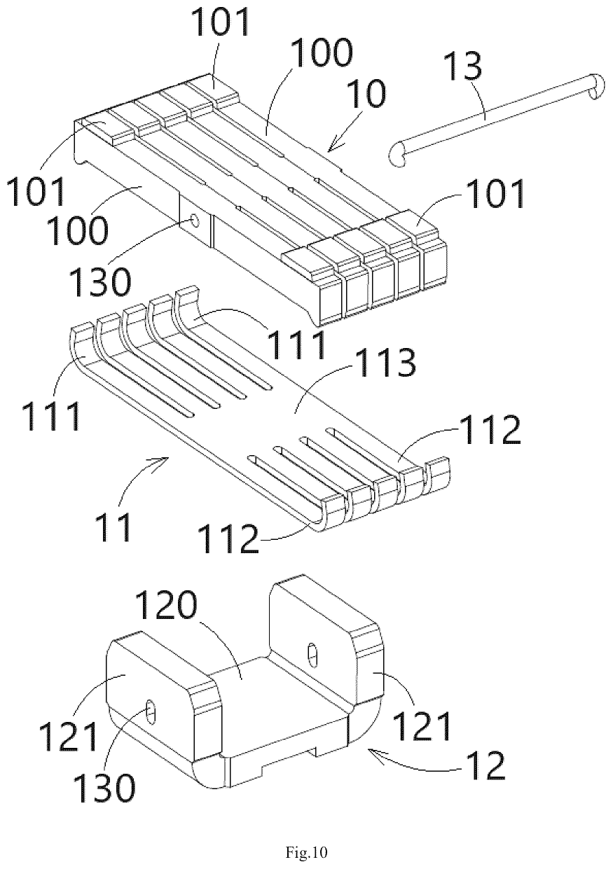

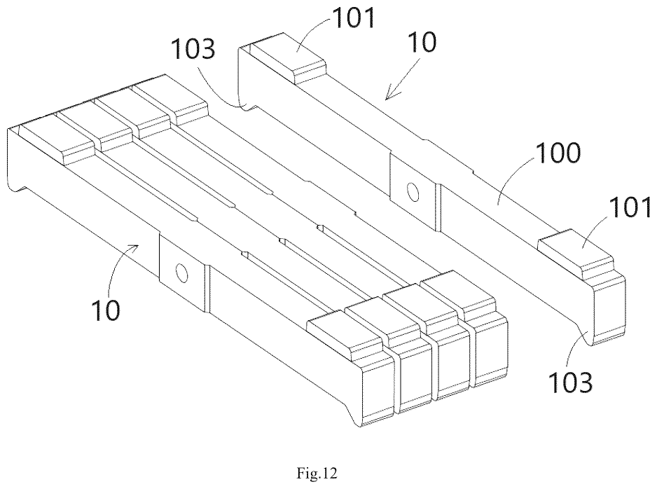

Another exemplary embodiment of a contactor movable contact module 1 will now be described with reference to FIGS. 9-13. As shown in FIGS. 9 and 12, the contactor movable contact module 1 includes multiple movable contacts 10. The multiple movable contacts 10 are arranged side by side in a transverse direction X. As shown in FIG. 10, each movable contact 10 includes a movable terminal 100 and two movable contact points 101. The movable terminal 100 has two opposite ends in the longitudinal direction Y and front and back sides opposite in the height direction Z. Two movable contact points 101 are respectively formed on the front surfaces of the two ends of the movable terminal 100. The movable contact points 101 at both ends of multiple movable contacts 10 are suitable for simultaneous electrical contact with the static contact points 601 of two static contacts 60, respectively, to electrically connect the two static contacts 60.

As shown in FIGS. 9-13, the contactor movable contact module 1 includes five movable contacts 10 arranged side by side. However, the present invention is not limited to this, and the contactor movable contact module 1 may include two, three, four, six or more movable contacts 10 arranged side by side.

As shown in FIGS. 9-11, the contactor movable contact module 1 also includes an elastic piece 11. The elastic piece 11 is assembled onto the back of the movable terminals 100 of the multiple movable contacts 10. As shown in FIG. 10, the elastic piece 11 includes a middle plate portion 113, a row of first cantilevers 111, and a row of second cantilevers 112. The middle plate portion 113 has two opposite sides in the longitudinal direction Y. The row of first cantilevers 111 is connected to one side of the middle plate portion 113, and is used to support on the back of one ends of the multiple movable terminals 100 arranged side by side. The row of second cantilevers 112 is connected to the other side of the middle plate portion 113, and is used to support the back of the other ends of multiple movable terminals 100 arranged side by side. In the illustrated embodiment, the elastic piece 11 can ensure that the movable contact points 101 of the multiple movable contacts 10 are in electrical contact with the static contact points 601 of the two static contacts 60 simultaneously.

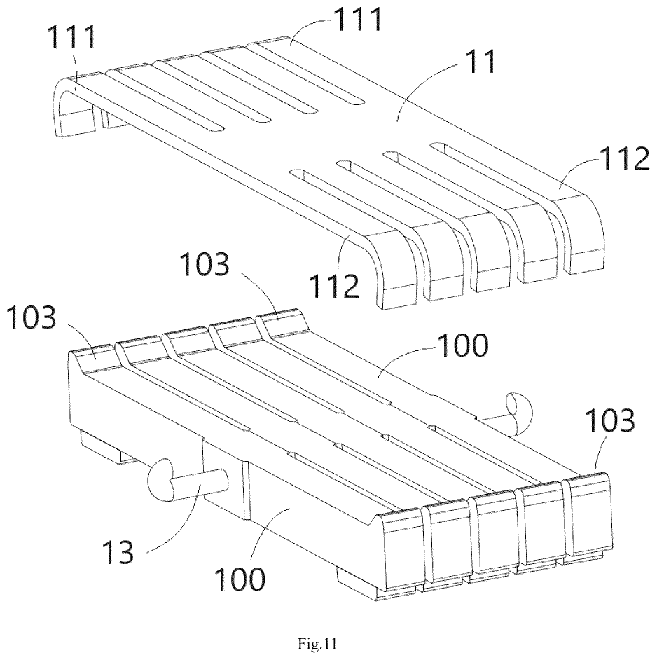

As shown in FIGS. 11-12, protrusions 103 are respectively formed on the back surfaces of both ends of the movable terminal 100. The first cantilever 111 and the second cantilever 112 of the elastic piece 11 are respectively pressed against the protrusions 103 on both ends of the movable terminal 100. There is a predetermined gap between the middle plate portion 113 of the elastic piece 11 and the movable terminal 100. The elastic piece 11 is a one-piece part, for example, it can be a one-piece stamped part.

As shown in FIGS. 9-10 and 13, the contactor movable contact module 1 further includes a support seat 12. The support seat 12 is U-shaped, including a bottom wall 120 and a pair of side walls 121. The multiple movable terminals 100 and the elastic piece 11 are assembled in the support seat 12, with the bottom wall 120 of the support seat 12 supported on the bottom surface of the middle plate portion 113 of the elastic piece 11, and the pair of side walls 121 of the support seat 12 respectively resting on the side surfaces of the two outermost movable terminals 100.

As shown in FIGS. 9-11, the contactor movable contact module 1 further includes a connecting rod 13. The connecting rod 13 passes through the multiple movable terminals 100 arranged side by side along the transverse direction X. The two ends of the connecting rod 13 are respectively fixed to the pair of side walls 121 of the support seat 12.

As shown in FIG. 10, through holes 130 allowing the connecting rod 13 to pass through are formed in the multiple movable terminals 100 and the pair of side walls 121 of the support seat 12, respectively. The two ends of the connecting rod 13 are bent and respectively pressed against the outer side of the pair of side walls 121 of the support seat 12. However, the present invention is not limited to this, and the two ends of the connecting rod 13 can be fixed to the pair of side walls 121 of the support seat 12 by welding, crimping, or riveting.

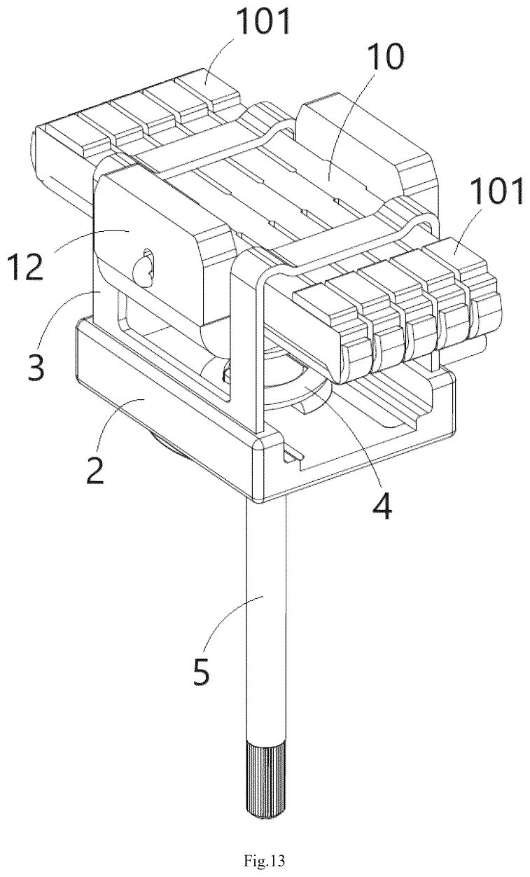

Another exemplary embodiment of a contactor movable contact assembly will now be described with reference to FIGS. 9-13. As shown in FIG. 13, the contactor movable contact assembly includes the contactor movable contact module 1, an insulation seat 2, a limit bracket 3, a spring 4, and a drive shaft 5. The limit bracket 3 is fixed to and located above the insulation seat 2. The contactor movable contact module 1 is installed into the limit bracket 3 in a movable manner. The spring 4 is compressed between the insulation seat 2 and the contactor movable contact module 1, allowing the contactor movable contact module 1 to float relative to the insulation seat 2. The drive shaft 5 is fixed to and located below the insulation seat 2. The insulation seat 2 electrically isolates the limit bracket 3, the spring 4, and the drive shaft 5 from each other. The insulation seat 2 is injection molded onto the lower end of the limit bracket 3 and the upper end of the drive shaft 5, making the insulation seat 2, limit bracket 3, and drive shaft 5 an integrated piece.

The contactor movable contact module 1 includes the support seat 12, a first positioning slot 123 is formed on the bottom surface of the support seat 12, and a second positioning slot 22 is formed on the top surface of the insulation seat 2. The two ends of the spring 4 are respectively positioned in the first positioning slot 123 and the second positioning slot 22.

Another exemplary embodiment of a contactor will now be described with reference to FIGS. 9-13. The contactor includes an inner housing, two static contacts 60, and a contactor movable contact assembly. An arc extinguishing chamber is defined in the inner housing. The two static contacts 60 are fixed to the inner housing and their static contact points 601 are located in the arc extinguishing chamber. The contactor movable contact assembly is installed in the arc extinguishing chamber and can be moved between a closed position and an open position. When the contactor movable contact assembly is moved to the closed position, the movable contact points 101 at both ends of the multiple movable contacts 10 make electrical contact with the static contact points 601 of the two static contacts 60, respectively, to electrically connect the two static contacts 60. When the contactor movable contact assembly is moved to the open position, the movable contact points 101 at both ends of multiple movable contacts 10 separate from the static contact points 601 of two static contacts 60.

The contactor further comprises an outer housing and an electromagnetic drive assembly. The inner housing is installed into the outer housing. The electromagnetic drive assembly is installed into the outer housing and located below the inner housing. The electromagnetic drive assembly is suitable for applying electromagnetic driving force on the drive shaft 5 of the contactor movable contact assembly to drive the contactor movable contact assembly to move from the open position to the closed position.

The contactor further comprises a reset spring, which is provided in the electromagnetic drive assembly and is adapted to apply an elastic reset force on the drive shaft 5. When the electromagnetic drive assembly loses power, the electromagnetic driving force applied to the drive shaft 5 disappears, and the drive shaft 5 is reset from the closed position to the open position under the action of the reset spring.

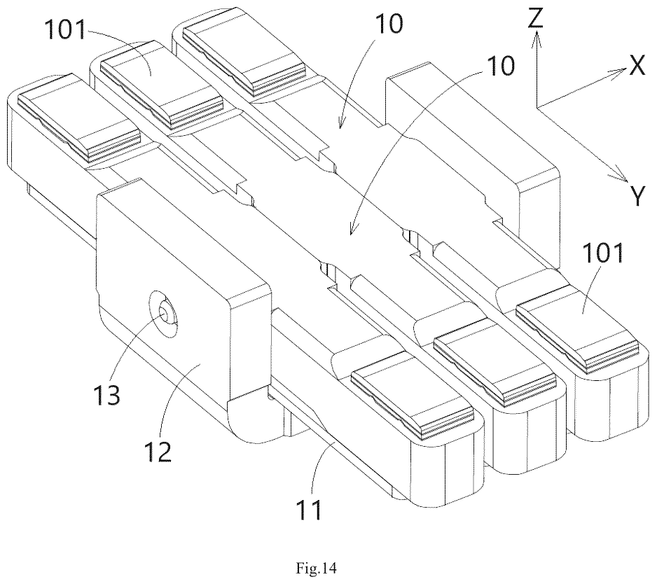

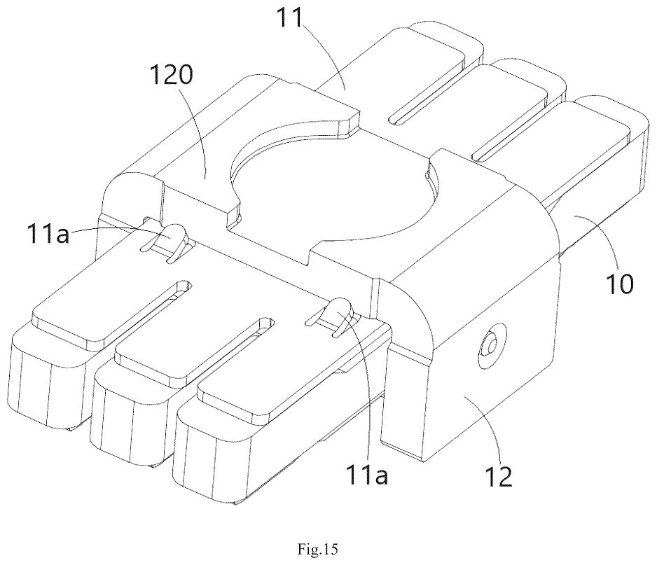

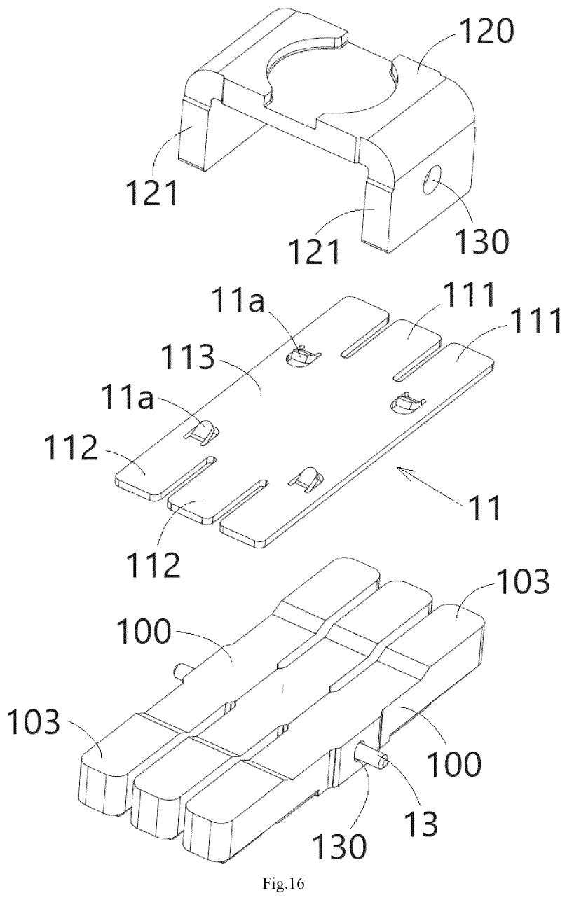

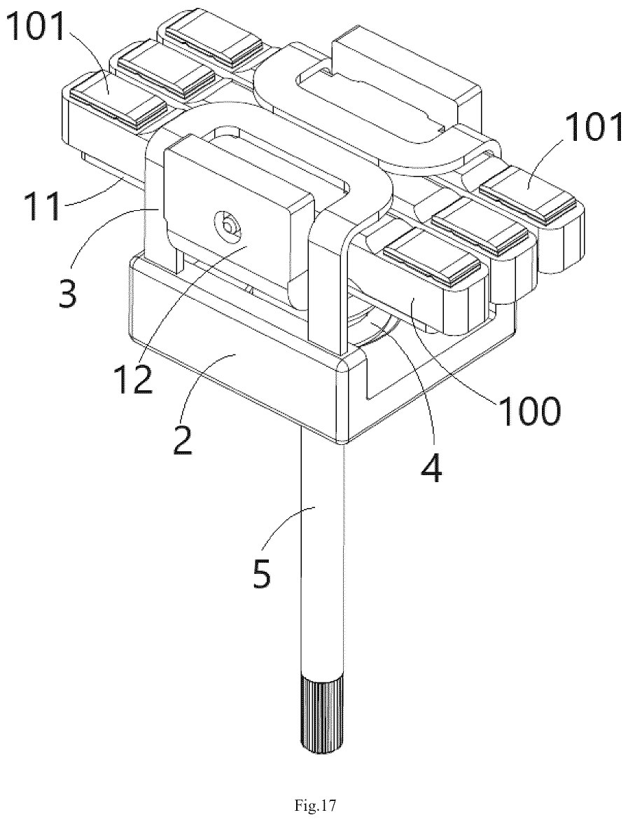

Yet another exemplary embodiment of a contactor movable contact module 1 will now be described with reference to FIGS. 14-17. As shown in FIG. 14, the contactor movable contact module 1 includes multiple movable contacts 10. The multiple movable contacts 10 are arranged side by side in a transverse direction X. Each movable contact 10 includes a movable terminal 100, as shown in FIG. 16, and two movable contact points 101, as shown in FIGS. 14 and 17. The movable terminal 100 has two opposite ends in the longitudinal direction Y and front and back surfaces opposite in the height direction Z. Two movable contact points 101 are respectively formed on the front surfaces of the two ends of the movable terminal 100. The movable contact points 101 at both ends of multiple movable contacts 10 are suitable for simultaneous electrical contact with the static contact points 601 of two static contacts 60, respectively, to electrically connect the two static contacts 60.

As shown in FIG. 16, the contactor movable contact module 1 includes three movable contacts 10 arranged side by side. However, the present invention is not limited to this, and the contactor movable contact module 1 may include two, four, five, six or more movable contacts 10 arranged side by side.

As shown in FIGS. 14-17, the contactor movable contact module 1 also includes an elastic piece 11. The elastic piece 11 is assembled onto the back of the movable terminals 100 of multiple movable contacts 10. As shown in FIG. 16, the elastic piece 11 includes a middle plate portion 113, a row of first cantilevers 111, and a row of second cantilevers 112. The middle plate portion 113 has two opposite sides in the longitudinal direction Y. The row of first cantilevers 111 is connected to one side of the middle plate portion 113, and is used to support on the back of one ends of multiple movable terminals 100 arranged side by side. The row of second cantilevers 112 is connected to the other side of the middle plate portion 113, and is used to support the back of the other ends of multiple movable terminals 100 arranged side by side. In the illustrated embodiment, the elastic piece 11 can ensure that the movable contact points 101 of multiple movable contacts 10 are in electrical contact with the static contact points 601 of two static contacts 60 simultaneously.

As shown in FIG. 16, protrusions 103 are respectively formed on the back surfaces of both ends of the movable terminal 100. The first cantilever 111 and the second cantilever 112 of the elastic piece 11 are respectively pressed against the protrusions 103 on both ends of the movable terminal 100. There is a predetermined gap between the middle plate portion 113 of the elastic piece 11 and the movable terminal 100. The elastic piece 11 is an one-piece part, for example, it can be an one-piece stamped part.

As shown in FIGS. 14-15 and 17, the contactor movable contact module 1 further includes a support seat 12. The support seat 12 is U-shaped, including a bottom wall 120 and a pair of side walls 121. The multiple movable terminals 100 and the elastic piece 11 are assembled in the support seat 12, with the bottom wall 120 of the support seat 12 supported on the bottom surface of the middle plate portion 113 of the elastic piece 11, and the pair of side walls 121 of the support seat 12 respectively resting on the side surfaces of the two outermost movable terminals 100.

As shown in FIG. 16, multiple elastic fingers 11a are formed on both sides of the middle plate portion 113 of the elastic piece 11. The bottom wall 120 of the support seat 12 has opposite sides in the longitudinal direction Y. The multiple elastic fingers 11a on one side of the middle plate portion 113 are pressed against one side of the bottom wall 120 of the support seat 12, and the multiple elastic fingers 11a on the other side of the middle plate portion 113 are pressed against the other side of the bottom wall 120 of the support seat 12. Therefore, in the illustrated embodiment, the bottom wall 120 of the support seat 12 is clamped between the elastic fingers 11a on both sides of the middle plate portion 113.

As shown in FIGS. 14 and 16, the contactor movable contact module 1 further includes a connecting rod 13. The connecting rod 13 passes through multiple movable terminals 100 arranged side by side along the transverse direction X. The two ends of the connecting rod 13 are respectively fixed to the pair of side walls 121 of the support seat 12.

As shown in FIG. 16, through holes 130 are formed in the multiple movable terminals 100 and the pair of side walls 121 of the support seat 12, respectively, to allow the connecting rod 13 to pass through. The two ends of the connecting rod 13 can be welded to the pair of side walls 121 of the support seat 12, respectively.

Yet another exemplary embodiment of a contactor movable contact assembly will now be described with reference to FIGS. 14-17. As shown in FIG. 17, the contactor movable contact assembly includes: a contactor movable contact module 1, an insulation seat 2, a limit bracket 3, a spring 4, and a drive shaft 5. The limit bracket 3 is fixed to and located above the insulation seat 2. The contactor movable contact module 1 is installed into the limit bracket 3 in a movable manner. The spring 4 is compressed between the insulation seat 2 and the contactor movable contact module 1, allowing the contactor movable contact module 1 to float relative to the insulation seat 2. The drive shaft 5 is fixed to and located below the insulation seat 2. The insulation seat 2 electrically isolates the limit bracket 3, the spring 4, and the drive shaft 5 from each other. The insulation seat 2 is injection molded onto the lower end of the limit bracket 3 and the upper end of the drive shaft 5, making the insulation seat 2, the limit bracket 3, and the drive shaft 5 an integrated piece.

The contactor movable contact module 1 includes a support seat 12, a first positioning slot 123 is formed on the bottom surface of the support seat 12, and a second positioning slot 22 is formed on the top surface of the insulation seat 2. The two ends of the spring 4 are respectively positioned in the first positioning slot 123 and the second positioning slot 22.

Yet another exemplary embodiment of a contactor will now be described with reference to FIGS. 14-17. The contactor includes an inner housing, two static contacts 60, and a contactor movable contact assembly. An arc extinguishing chamber is defined in the inner housing. The two static contacts 60 are fixed to the inner housing and their static contact points 601 are located in the arc extinguishing chamber. The contactor movable contact assembly is installed in the arc extinguishing chamber and can be moved between a closed position and an open position. When the contactor movable contact assembly is moved to the closed position, the movable contact points 101 at both ends of the multiple movable contacts 10 make electrical contact with the static contact points 601 of the two static contacts 60, respectively, to electrically connect the two static contacts 60. When the contactor movable contact assembly is moved to the open position, the movable contact points 101 at both ends of multiple movable contacts 10 separate from the static contact points 601 of two static contacts 60.

The contactor further comprises an outer housing and an electromagnetic drive assembly. The inner housing is installed into the outer housing. The electromagnetic drive assembly is installed into the outer housing and located below the inner housing. The electromagnetic drive assembly is suitable for applying electromagnetic driving force on the drive shaft 5 of the contactor movable contact assembly to drive the contactor movable contact assembly to move from the open position to the closed position.

The contactor further comprises a reset spring, which is provided in the electromagnetic drive assembly and is adapted to apply an elastic reset force on the drive shaft 5. When the electromagnetic drive assembly loses power, the electromagnetic driving force applied to the drive shaft 5 disappears, and the drive shaft 5 is reset from the closed position to the open position under the action of the reset spring.

In the aforementioned exemplary embodiments according to the present invention, the contactor comprises multiple movable contacts 10 arranged side by side, with one movable contact point 101 at each end of each movable contact 10. Therefore, the present invention can reduce the current flowing through each movable contact point 101, thereby reducing heat generation and electric repulsion, and improving the ability of the contactor to resist short-circuit current.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A contactor movable contact module, comprising:
a plurality of movable contacts arranged side by side in a transverse direction, each movable contact includes a movable terminal and two movable contact points, the movable terminal has two ends opposite in a longitudinal direction and a front surface and a back surface opposite in a height direction, the two movable contact points are respectively formed on the front surfaces of the two ends of the movable terminal, the movable contact points at both ends of the plurality of movable contacts respectively simultaneously electrically contact static contact points of two static contacts to electrically connect the two static contacts.

2. The contactor movable contact module of claim 1, further comprising a support seat which is U-shaped and includes a bottom wall and a pair of side walls, the movable terminals of the plurality of movable contacts are assembled in the support seat, the bottom wall of the support seat is supported on the back surfaces of each movable terminal, the pair of side walls of the support seat respectively rest on sides of a two outermost movable terminals.

3. The contactor movable contact module of claim 2, wherein a positioning protrusion is formed on the bottom wall of the support seat, and a positioning slot is formed on the back of each movable terminal, the positioning protrusion is positioned in the positioning slot.

4. The contactor movable contact module of claim 2, wherein a plurality of positioning protrusions are formed on the bottom wall of the support seat, and positioning slots are respectively formed on the back of each movable terminal, each positioning protrusion is positioned in one positioning slot.

5. The contactor movable contact module of claim 1, further comprising an elastic piece assembled onto the back of each movable terminal, the elastic piece includes a middle plate portion, a row of first cantilevers, and a row of second cantilevers, the middle plate portion has two opposite sides in the longitudinal direction, the row of first cantilevers is connected to one side of the middle plate portion, for supporting on the back of one end of each movable terminal arranged side by side, and the row of second cantilevers is connected to an other side of the middle plate portion, for supporting on the back of an other end of each movable terminal arranged side by side.

6. The contactor movable contact module of claim 5, wherein protrusions are respectively formed on the back surfaces of both ends of each movable terminal, the row of first cantilevers and the row of second cantilevers are respectively pressed against the protrusions on both ends of each movable terminal, there is a predetermined gap between the middle plate portion of the elastic piece and each movable terminal.

7. The contactor movable contact module of claim 5, wherein the elastic piece is an integral part.

8. The contactor movable contact module of claim 5, further comprising a support seat, the support seat is U-shaped and includes a bottom wall and a pair of side walls.

9. The contactor movable contact module of claim 8, wherein each movable terminal and the elastic piece are assembled in the support seat, the bottom wall of the support seat is supported on a bottom surface of the middle plate portion of the elastic piece, and the pair of side walls of the support seat respectively rest on side surfaces of a two outermost movable terminals.

10. The contactor movable contact module of claim 9, wherein a plurality of elastic fingers are formed on both sides of the middle plate portion of the elastic piece, the bottom wall of the support seat is clamped between the elastic fingers on both sides of the middle plate portion.

11. The contactor movable contact module of claim 8, further comprising a connecting rod that passes through each movable terminal arranged side by side along the transverse direction, two ends of the connecting rod are respectively fixed to the pair of side walls of the support seat.

12. The contactor movable contact module of claim 11, wherein through holes are respectively formed in each movable terminal and the pair of side walls of the support seat to allow the connecting rod to pass through, the two ends of the connecting rod are bent and respectively pressed against an outer side of the pair of side walls of the support seat.

13. The contactor movable contact module of claim 1, wherein the contactor movable contact module comprises two, three, four, or five movable contacts arranged side by side in the transverse direction.

14. A contactor movable contact assembly, comprising:
an insulation seat;
a limit bracket fixed to and located above the insulation seat;
a contactor movable contact module movably installed into the limit bracket, the contactor movable contact module includes a plurality of movable contacts arranged side by side in a transverse direction, each movable contact includes a movable terminal and two movable contact points, the movable terminal has two ends opposite in a longitudinal direction and a front surface and a back surface opposite in a height direction, the two movable contact points are respectively formed on the front surfaces of the two ends of the movable terminal, the movable contact points at both ends of the plurality of movable contacts respectively simultaneously electrically contact static contact points of two static contacts to electrically connect the two static contacts;
a spring compressed between the insulation seat and the contactor movable contact module, the spring allows the contactor movable contact module to float relative to the insulation seat; and
a drive shaft fixed to and located below the insulation seat, the insulation seat electrically isolates the limit bracket, the spring, and the drive shaft from each other.

15. The contactor movable contact assembly of claim 14, wherein the insulation seat is injection molded onto a lower end of the limit bracket and an upper end of the drive shaft, such that the insulation seat, the limit bracket, and the drive shaft are an integrated piece.

16. The contactor movable contact assembly of claim 14, wherein the contactor movable contact module has a support seat, a first positioning slot is formed on a bottom surface of the support seat, a second positioning slot is formed on a top surface of the insulation seat, two ends of the spring are respectively positioned in the first positioning slot and the second positioning slot.

17. A contactor, comprising:
an inner housing, an arc extinguishing chamber is defined inside the inner housing;
two static contacts fixed to the inner housing, static contact points of each static contact are located in the arc extinguishing chamber; and
a contactor movable contact assembly movably installed in the arc extinguishing chamber and movable between a closed position and an open position, the contactor movable contact assembly includes an insulation seat, a limit bracket fixed to and located above the insulation seat, a contactor movable contact module movably installed into the limit bracket, a spring compressed between the insulation seat and the contactor movable contact module, and a drive shaft fixed to and located below the insulation seat, the contactor movable contact module is movably installed into the limit bracket, the contactor movable contact module includes a plurality of movable contacts arranged side by side in a transverse direction, each movable contact includes a movable terminal and two movable contact points, the movable terminal has two ends opposite in a longitudinal direction and a front surface and a back surface opposite in a height direction, the two movable contact points are respectively formed on the front surfaces of the two ends of the movable terminal, the movable contact points at both ends of the plurality of movable contacts respectively simultaneously electrically contact static contact points of two static contacts to electrically connect the two static contacts, the spring allows the contactor movable contact module to float relative to the insulation seat, the insulation seat electrically isolates the limit bracket, the spring, and the drive shaft from each other, when the contactor movable contact assembly is moved to the closed position, the movable contact points at both ends of each movable contacts respectively make electrical contact with the static contact points of the two static contacts to electrically connect the two static contacts, when the contactor movable contact assembly is moved to the open position, the movable contact points at both ends of each movable contact are separated from the static contact points of the two static contacts.

18. The contactor of claim 17, further comprising an outer housing and an electromagnetic drive assembly, the inner housing is installed in the outer housing, the electromagnetic drive assembly is installed in the outer housing and located below the inner housing, the electromagnetic drive assembly applies an electromagnetic driving force on the drive shaft of the contactor movable contact assembly to drive the contactor movable contact assembly to move from the open position to the closed position.

19. The contactor of claim 18, further comprising a reset spring installed in the electromagnetic drive assembly and suitable for applying an elastic reset force on the drive shaft, when the electromagnetic drive assembly loses power, the electromagnetic driving force disappears, and the drive shaft is reset from the closed position to the open position under an action of the reset spring.
